(19) United States
(12) Patent Application Publication
(10) Pub. No.: US 2013/0011577 A1
(43) Pub. Date: Jan. 10, 2013

(54) METHOD FOR PROVIDING A METAL ELECTRODE ON THE SURFACE OF A HYDROPHOBIC MATERIAL

(75) Inventors: Gilgueng Hwang, Saint-Remy Les Chevreuse (FR); Dogan Sinan Haliyo, Paris (FR); Stéphane Regnier, Bois-Colombes (FR)

(73) Assignees: CENTRE NATIONAL DE LA RECHERCHE SCIENTIFIQUE, PARIS (FR); UNIVERSITE PIERRE ET MARIE CURIE (PARIS 6), PARIS (FR)

(21) Appl. No.: 13/636,267

(22) PCT Filed: Mar. 24, 2011
(86) PCT No.: PCT/EP11/01476

§ 371 Date: Sep. 20, 2012

(30) Foreign Application Priority Data
Mar. 24, 2010 (FR) 1052120

(51) Int. Cl. B05D 3/06; B82Y 30/00

(52) U.S. Cl. 427/555; 977/734

(57) ABSTRACT

A method of making a metal electrode on the surface of a hydrophobic material (7), the method comprising the steps of: [1] bringing one end of a capillary (5) containing a fluid that includes particles of metal dissolved in a solvent close to a zone of the surface of the material (7); and [2] illuminating said zone by means of laser radiation (3) so as to have the effects of causing a drop of fluid to flow from the capillary, of depositing the drop on the zone, of evaporating the solvent contained in the drop, and of annealing the metal particles on the surface of the material in order to form the electrode.

The invention relates to a method of making a metal electrode on the surface of a hydrophobic material.

### TECHNOLOGICAL BACKGROUND OF THE INVENTION

Hydrophobic materials are known that present physical characteristics that are advantageous in the field of electronics. By way of example, graphene possesses photonic characteristics that could contribute greatly to the field of optoelectronics. Nevertheless, it is difficult to produce a high-quality electronic device from a hydrophobic material. It is particularly difficult to deposit an electrode on a pure hydrophobic material.

Proposals have been made to make a metal electrode by a method including the step of bringing a hydrophobic material close to one end of a capillary that contains a fluid having particles of metal in solution. A drop of fluid is then deposited on the surface of the material by the electro-spray ionization (ESI) technique: the end of the capillary and the surface of the material are subjected to a very strong electric field by means of an electrode in contact with the end of the capillary and an electrode in contact with the surface of the hydrophobic material so that an electric current is established between the electrode. The metal particles contained in the fluid of the capillary then migrate under the effect of the electric field towards the electrode in contact with the surface of the material. Because of the magnitude of the electric field, the metal particles are violently expelled in drops of fluid towards the surface of the material. During this expulsion, the solvent then evaporates naturally into ambient air, which evaporation may be encouraged by the presence of a gas such as nitrogen.

Nevertheless, such a method requires a magnetic field that is so strong that, by heating, it gives rise to local evaporation of the fluid in the end of the capillary. Only the metal particles remain, which particles then block the end of the capillary, thereby preventing drops from being formed.

### OBJECT OF THE INVENTION

An object of the invention is to provide a method of making a metal electrode on the surface of a hydrophobic material, which method makes it possible to obviate the above-mentioned drawbacks.

### BRIEF DESCRIPTION OF THE INVENTION

In order to achieve this object, the invention provides a method of making a metal electrode on the surface of a hydrophobic material, the method comprising the steps of:
bringing one end of a capillary containing a fluid that includes particles of metal dissolved in a solvent close to a zone of the surface of the material; and
illuminating said zone by means of laser radiation so as to have the effects of causing a drop of fluid to flow from the capillary, of depositing the drop on the zone, of evaporating the solvent contained in the drop, and of annealing the metal particles on the surface of the material in order to form the electrode.

The laser radiation thus creates electrostatic charges by locally ionizing the hydrophobic material. Electrostatic forces are thus exerted between charged particles contained in the material and charged particles contained in the particles of metal of the fluid. These electrostatic forces create an electric field between the end of the capillary and the surface of the material. Under the action of the electric field, movement is imparted to free charges contained in the fluid at the end of the capillary, thereby giving rise to macroscopic movement of the fluid. Such a phenomenon is known as the electro-osmosis phenomenon. The movement of the fluid thus causes drops to form and flow at the end of the capillary. The laser radiation then enables the metal electrode to be formed once the drop has been deposited on the surface of the material.

The end of the capillary is thus not subjected in any way to high voltage, so that the invention avoids locally evaporating the fluid at the end of the capillary.

### BRIEF DESCRIPTION OF THE DRAWING

Other characteristics and advantages of the invention appear on reading the following description of a particular, non-limiting embodiment of the invention. Reference is made to the accompanying drawing, in which:

FIG. 1 is a diagrammatic representation of an operating device implementing the method of the invention; and

FIG. 2 is a diagrammatic representation of various steps (a, b, c, d) of the method of the invention.

### DETAILED DESCRIPTION OF THE INVENTION

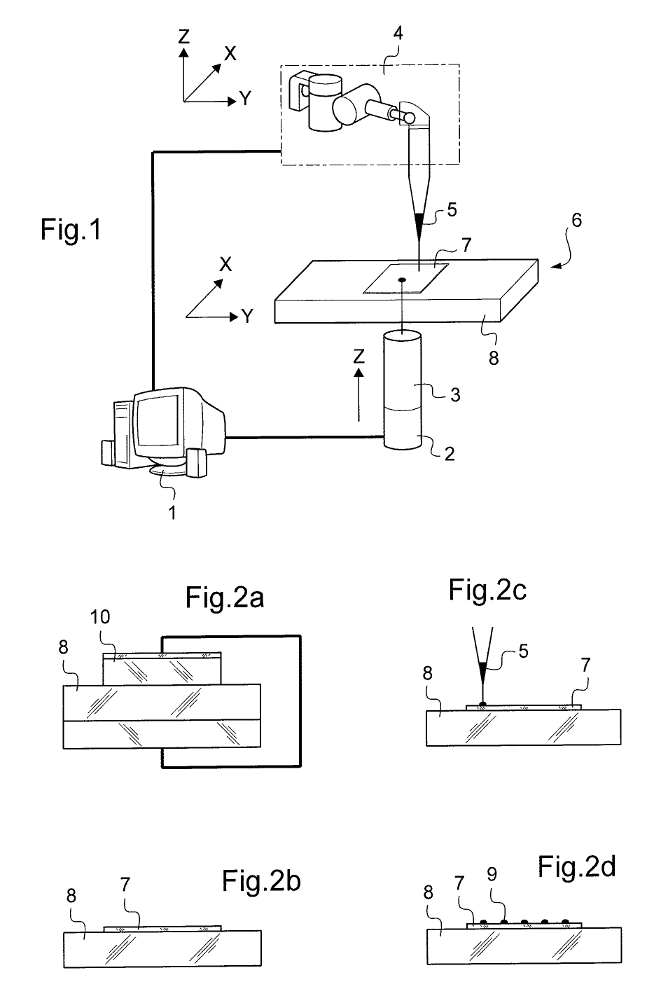

With reference to FIG. 1, the method of the invention is designed to be implemented in an operating device comprising a computer 1 enabling an inverted microscope 2 to be controlled, which microscope is connected to a laser 3, the inverted microscope 2 and the laser 3 forming a stationary assembly. The computer 1 also controls a first manipulator 4 capable in operation of moving a capillary 5 relative to the microscope 2 and the laser 3 along two translation axes X and Y in a plane and along a translation axis Z perpendicular to the plane. The computer 1 also controls a manipulator (not shown) that is capable in operation of moving a sample 6 relative to the microscope 2 and to the laser 3 along the two translation axes X and Y in the plane and along the translation axis Z perpendicular to the plane.

The capillary 5 contains a fluid that includes particles of metal, particles of gold in this example, dissolved in a solvent.

The sample 6 has a first fine layer of a hydrophobic material 7 deposited on an appropriate substrate 8. In a preferred embodiment, the first layer 7 is made of graphene and the substrate 8 is made of borosilicate glass. In the operating device, the substrate 8 is oriented to face the laser 3 and the first layer 7 is oriented to face the capillary 5.

By way of example, with reference to step (a) of FIG. 2, the sample 6 may be prepared as follows. A thick layer of hydrophobic material 10 is placed against a surface of the substrate 8. The substrate 8 is then raised to high temperature, thereby causing oxides in the substrate 8 to be dissociated. The substrate 8 and the thick layer 10 are then subjected to an electric field by means of an electrode in contact with the substrate 8 and an electrode in contact with the thick layer 10. Oxide separation in the substrate 8 makes the substrate 8 weakly conductive, and in particular sufficiently conductive for an electric current to become established between the electrodes under the application of the electric field. Under the effect of the electric field, the mobile ions migrate towards the electrode in contact with the substrate 8, leaving behind the stationary ions of opposite charge, thereby creating an electric charge at the interface between the substrate 8 and the thick layer 10. After the electric field has been applied for a certain length of time, the surface of the thick layer 10 in contact with the substrate 8 bonds strongly to the substrate 8.

With reference to step (b) of FIG. 2, it then suffices to eliminate the major portion of the thick layer 10 in order to leave behind only the first fine layer 7 bonded to the substrate 8, thereby forming the sample 6.

The method of depositing a metal electrode then takes place as follows. With reference to step (c) of FIG. 2, once the sample is in place in the FIG. 1 device, one end of the capillary 5 is moved close to a zone of the first layer 7. The laser 3 then illuminates the zone of the first layer 7, thereby causing electrostatic charge to be created by locally ionizing the first layer 7. Electrostatic forces thus act between charged particles in the first layer 7 and charged particles contained in the metal particles of the fluid. These electrostatic forces thus create an electric field between the end of the capillary 5 and the zone of the first layer 7. By electro-osmosis, the electric field causes the fluid contained in the capillary 5 to move, thereby in turn causing a drop 9 to form and flow at the end of the capillary 5. By dropping onto the zone of the first layer 7, the drop 9 forms a deposit of fluid. The fluid contained in the capillary 5 is thus deposited in simple manner on the first layer by means of the electrostatic forces created between charged particles contained in the first layer 7 and charged particles contained in the particles of metal in the fluid, and by means of the electro-osmotic field created in the capillary 5. The zone where deposition of the drop 9 takes place is defined by moving the sample 6 relative to the capillary 5. Similarly, the dimensions of said deposit are controlled by moving the sample 6 closer to or further away from the capillary 5.

With reference to step (d) of FIG. 2, the laser acts through the substrate 8 to illuminate the zone where the drop 9 has been deposited, thereby locally heating said zone. The drop 9 is thus also heated, thereby causing the solvent contained in the drop 9 to evaporate progressively, with the laser 3 concentrating the particles of gold in the center of the drop 9.

Simultaneously, the heating of the drop 9 causes the particles of metal on the surface of the first layer 7 to be annealed, thereby forming a metal electrode on the surface of the first layer 7.

The laser illumination thus performs several roles:

it contributes to creating the electrostatic charges by locally ionizing the hydrophobic material;

it causes the solvent contained in the drop to evaporate progressively, thereby concentrating the particles of gold; and

it enables the particles to be annealed and bonded to the hydrophobic material.

Naturally, the invention is not limited to the implementation described and it may be subjected to variant implementations without going beyond the ambit of the invention as defined by the claims.

In particular, although the radiation from the laser 3 in this example passes through the substrate 8 in order to illuminate the zone of the first layer 7, it would naturally be possible to illuminate the zone of the first layer 7 directly without passing through the substrate by illuminating the free face of the hydrophobic material directly.

1. A method of making a metal electrode on the surface of a hydrophobic material (7), the method comprising the steps of:
bringing one end of a capillary (5) containing a fluid that includes particles of metal dissolved in a solvent close to a zone of the surface of the material (7); and
illuminating said zone by means of laser radiation (3) so as to have the effects of causing a drop of fluid to flow from the capillary, of depositing the drop on the zone, of evaporating the solvent contained in the drop, and of annealing the metal particles on the surface of the material in order to form the electrode.

2. A method according to claim 1, wherein the material (7) is graphene.

3. A method according to claim 1, wherein the particles of metal are particles of gold.

4. A method according to claim 1, wherein the material (7) is previously bonded to a substrate (8).

5. A method according to claim 4, wherein the substrate (8) is made of borosilicate glass.

6. A method according to claim 4, wherein the laser radiation passes through the substrate (8) in order to illuminate the zone of the material (7).
